(19) United States
(12) Patent Application Publication
(10) Pub. No.: US 2011/0032232 A1
(43) Pub. Date: Feb. 10, 2011

(54) Pixel Circuit

(75) Inventor: Euan C. Smith, Cambridgeshire (GB)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: CAMBRIDGE DISPLAY TECHNOLOGY LTD., Cambridgeshire (GB)

(21) Appl. No.: 12/680,488

(22) PCT Filed: Sep. 26, 2008
(86) PCT No.: PCT/GB2008/003300

§ 371 Date: Oct. 25, 2010

(30) Foreign Application Priority Data
Oct. 5, 2007 (GB) 0719511.8

(51) Int. Cl. G09G 5/00

(52) U.S. Cl. 345/211

(57) ABSTRACT

A pixel driver circuit for active matrix driving of an organic light emitting diode (OLED) comprises a drive transistor having a current path connected to a first voltage supply line at one end and to an OLED at the other end and a gate terminal connected to a storage element connected between gate and source of the drive transistor to memorize a drive signal for the drive transistor under the control of a first switch transistor having a gate connection to a first selection line and a current path connected between gate and drain of the drive transistor, and a second switch transistor having a gate connection to a second selection line, wherein the second switch transistor has a current path connected to the data line at one end and a node at the other end located between the drive transistor and the OLED.

The present invention relates, in general, to a pixel circuit for an active matrix driven organic electroluminescent device.

Organic light emitting diodes (OLEDs) comprise a particularly preferred form of electro-optic emitter. Displays fabricated using OLEDs provide a number of advantages over LCD and other flat panel technologies. They are bright, fast switching (compared to LCDs), provide a wide viewing angle and are easy and cheap to fabricate on a variety of substrates.

Organic (which here includes organometallic) LEDs may be fabricated using materials including polymers, small molecules and dendrimers, in a range of colours which depend upon the materials employed. Examples of polymer-based OLEDs are described in WO 90/13148, WO 95/06400 and WO 99/48160; examples of dendrimer-based materials are described in WO 99/21935 and WO 02/067343; and examples of so-called small molecule based devices are described in U.S. Pat. No. 4,539,507.

With reference to FIG. 1, the general device architecture of an OLED comprises a transparent glass or plastic substrate 1, and anode 2 of indium tin oxide and a cathode 4. An organic electroluminescent layer 3 is provided between anode 2 and cathode 4. Further layers may be located between anode 2 and cathode 4, such as charge transporting, charge injecting or charge blocking layers.

Electroluminescent layer 3 may be patterned or unpatterned. For example, a device used as an illumination source may be unpatterned. A device comprising a patterned layer may be a passive matrix display or an active matrix display. In a passive matrix display, the anode 2 is formed of parallel stripes of anode material and the electroluminescent layer 3 is deposited over the striped anode 2. Parallel stripes of the cathode 4 are arranged over the electroluminescent layer 3 orthogonal to the parallel stripes of the anode 2. Adjacent stripes of cathode 4 are typically separated by stripes of insulating material—so called “cathode separators”, formed by photolithography. Passive matrix displays are driven using column and row drivers by repetitively scanning the display to address individual pixels along columns and rows represented by the orthogonal anode and cathode stripes respectively. So-called active matrix displays typically have a patterned electroluminescent layer 3 used in combination with a patterned anode 2 and an unpatterned cathode 4. In an active matrix driving scheme each pixel of a display comprises its own associated drive circuitry. The driver circuitry typically comprising at least a memory element such as a capacitor, an address transistor or switching transistor and a drive transistor.

An OLED device may be fully transparent where both anode 2 and cathode 4 are transparent. So called “Top-emitting” OLED devices having transparent cathodes are particularly advantageous for active matrix devices because emission through a transparent anode in such devices is at least partially blocked by drive circuitry located underneath the emissive pixels.

It will be appreciated that a transparent cathode device need not have a transparent anode (unless of course a fully transparent device is desired) and so the transparent anode used for bottom emitting devices may be replaced or supplemented with a layer of reflective material such as a layer of aluminium. Examples of transparent cathode devices are disclosed in, for example, GB 2348316.

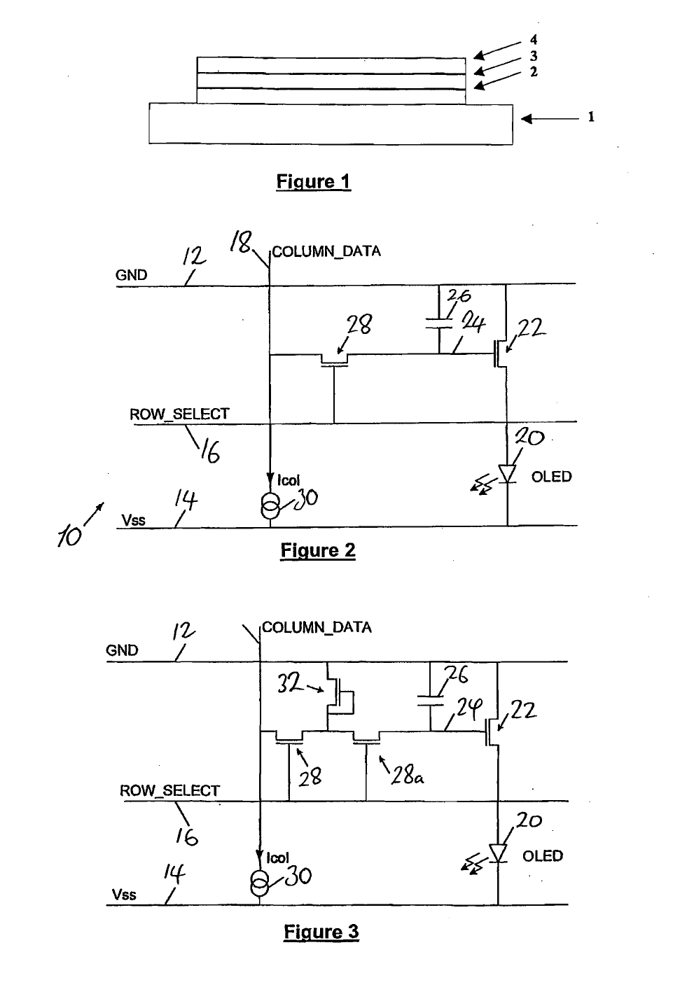

FIG. 2 shows an example of a voltage controlled OLED active matrix pixel circuit 10. A pixel circuit 10 is provided for each pixel of the display and ground 12, Vss 14, row select 16 and column data 18 bus lines are provided interconnecting the pixels. Accordingly, each pixel has a power and ground connection and each row of pixels has a common row select line 16 and each column of pixels has a common data line 18.

Each pixel has an OLED 20 connected in series with a driver transistor 22 between ground and power lines 12, 14. A gate terminal 24 of driver transistor 22 is connected to a storage capacitor 26 and an addressing transistor 28 connects gate terminal 24 to column data line 18 under the control of row select line 16. The addressing transistor 28 is a thin film Field Effect Transistor (FET) switch which connects column data line 18 to the gate terminal 24 and the capacitor 26 when row select line 16 is activated. In this way, when the addressing transistor 28 is ON a voltage on column data line 18 can be stored on the capacitor 26. This is generally known as programming the pixel circuit. The voltage is retained on the capacitor 26 for at least the frame refresh period because of the relatively high impedances of the gate connection to the driver transistor 22 and of the addressing transistor 28 in an OFF state.

The driver transistor 22 is typically also a FET transistor and passes a (drain-source) current which is dependent upon the transistor's gate voltage less a threshold voltage. The voltage at gate terminal 24 therefore controls the current through OLED 20 and in turn the brightness of OLED 20. The voltage controlled circuit of FIG. 2 may suffer from a number of drawbacks, in particular because the OLED 20 emission depends non-linearly on the applied voltage and current control is preferable since the light output from an OLED is proportional to the current it passes. FIG. 3 (in which like elements to those of FIG. 2 are represented by like reference numerals) illustrates a variant of the circuit of FIG. 2 which employs current control. A current on the (column) data line, set by current generator 30 “programs” the current through FET 32, which in turn sets the current through OLED 20 since when transistor 28a is ON (matched) transistors 32 and drive transistor 22 form a current mirror.

Where the active matrix drive circuitry comprises organic thin film transistors (OTFTs) or transistors fabricated in LTPs (Low Temperature Polysilicon) the transistors are generally referred to as p-type devices.

Where the active matrix drive circuitry comprises transistors fabricated in hydrogenated amorphous silicon (a-Si:H) the transistors are generally referred to as n-type devices.

One problem encountered in FET technology (a-Si:H and LTPs) is shift in threshold voltage (Vth) for continuous operation. Generally, the shift in Vth for a-Si:H transistors is very sensitive to voltage stress. Application of the high voltages above threshold needed for a drive transistor causes large changes in threshold voltage. This manifests itself as different driving transistors passing different driving currents to an OLED for the same applied programming signal. Accordingly, this may result in a problem of non-linearities in brightness of pixels across a display.

One approach to solve the aforementioned problem has been put forward by Shirasaki, T et al (hereinafter Shirasaki) in “Solution for Large-Area Full-Color OLED Television Light Emitting Polymer and a-Si TFT Technologies” vol II, p 275-278, December 2004 in Proceedings of International Display Workshop (IDW) and available on-line at http://hat-lab.ed.kyusha-u.ac.jp//Documents/AMD3_OLED5-1.pdf. This paper discloses a three transistor a-Si TFT pixel circuit in which it is purported that the pixel circuit and driving scheme can compensate for instability caused by a shift in threshold voltage.

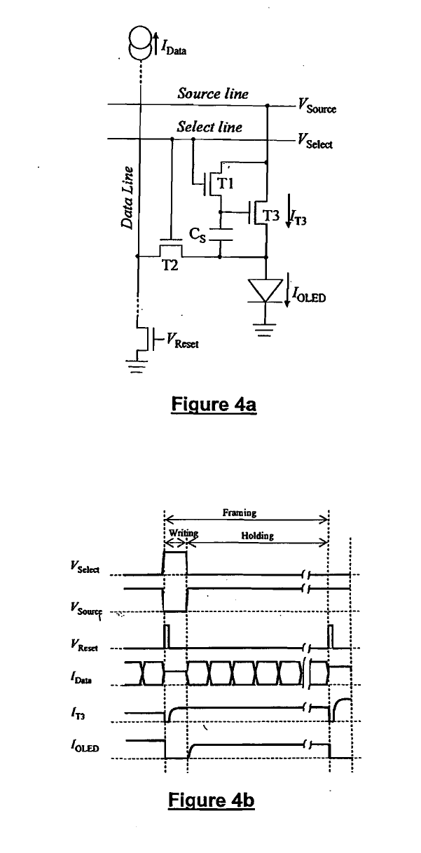

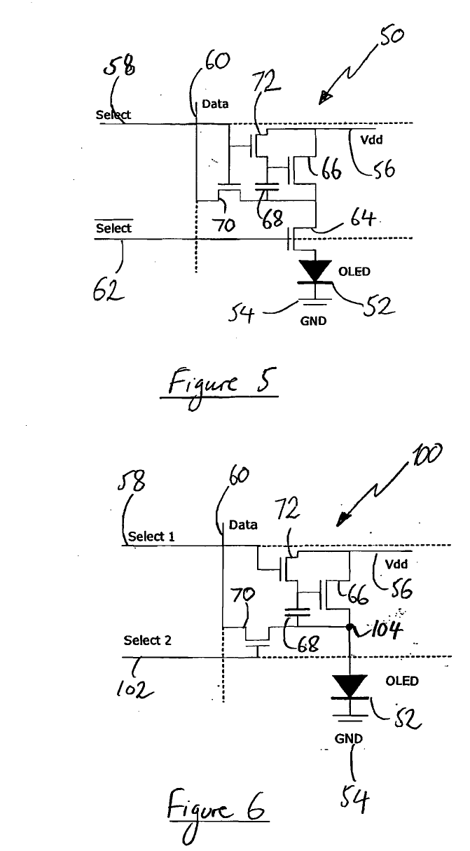

Referring to FIGS. 4a and 4b which illustrate in FIG. 4a, a pixel circuit of Shirasaki and in FIG. 4b an associated timing chart for the pixel circuit of FIG. 4a, it is seen that during driving of the pixel circuit, the source voltage, V_{Source} must be varied such that during the writing stage V_{Source} is low and during the holding or driving stage V_{source} returns to high. In some cases this may not be desirable, for example, if existing “off the shelf” driver components are used, a standard LCD row driver may not be able to provide these varying non-standard signals. The modulation of V_{Source} can also cause some modification of the capacitance thereby reducing the drive current I_{T3} below that intended.

Other methods suggested for compensation schemes require more complicated pixel circuit configurations and drive schemes. In any device, there exists an upper limit on the amount of “real-estate” for additional devices together with a need to keep fabrication simple. Moreover, an aperture ratio of a display, defined generally as the space occupied by viewable emitting pixels compared to that used by bus lines or devices is reduced the more devices or lines that are included as a device.

A further parameter which affects the light emission of an OLED over time comes from the OLED itself and in particular due to aging of the OLED. As OLEDs age they generally become less efficient causing a loss of light output. The loss of light output is generally thought to arise from a decrease in current-to-photon conversion efficiency and from an increase in OLED resistance that results in a reduction of current through the OLED for a given drive signal.

It is desirable to provide an improved pixel circuit which seeks to compensate for threshold variation in a drive transistor of the pixel circuit.

It is also desirable to provide an improved pixel circuit which seeks to compensate for OLED aging.

It is also desirable to provide an improved pixel circuit that reduces the number of bus lines so that the aperture ratio of the device can be increased.

According to a first aspect of the present invention there is provided a pixel driver pixel driver circuit for driving an organic light-emitting diode (OLED) comprising: a first selection line; a second selection line; a data line; a first voltage supply line; and a drive transistor having a current path connected to the first voltage supply line at one end and the OLED at the other end and a gate terminal connected to a storage element connected between gate and source of the drive transistor to memorise a drive signal for the drive transistor under the control of a first switch transistor having a gate connection to the first selection line and a current path connected between gate and drain of the drive transistor; a second switch transistor having a gate connection to the second selection line, wherein the second switch transistor has a current path connected to the data line at one end and a node at the other end located between the drive transistor and the OLED.

In a further embodiment, a third selection line and a third switch transistor having a gate connection to the third selection line is provided, wherein the third switch transistor is located in the current path of the drive transistor in series between the OLED and drive transistor.

Preferably, the first selection line is a non-inverted selection line and the third selection line is an inverted selection line such that when the first selection line is HIGH the third selection line is LOW.

More preferably, the first and second selection lines are common.

Preferably, the first voltage supply line and another selection line are formed as a combined voltage supply and selection line.

Preferably, the first voltage supply line and another selection line are formed as a combined voltage supply and selection line and wherein the first and second selection lines are common.

In a further embodiment, the another selection line is the first selection line of a neighbouring pixel circuit sharing a common data line.

In embodiments of the present invention, the drive transistor is an n-type transistor and preferably fabricated from amorphous silicon.

Preferably, the OLED has a current path such that an anode terminal of the OLED is connected to the drive transistor.

The present invention also provides a plurality of pixel driver circuits as described above and arranged in row and columns, each data line being shared by each pixel circuit in a column and each combined voltage supply line and all selection lines being shared by each pixel circuit in a row, wherein, for a particular column and during addressing the combined voltage supply and selection line of the n−1th pixel driver circuit acts as the first voltage supply line to the nth pixel driver circuit and the combined voltage supply and selection line of the n+1th pixel driver circuit acts as a selection line to the nth pixel driver circuit.

Preferably, the pixel driver circuits are arranged in row and columns to form the display and each data line is shared by each pixel circuit in a column and each selection line is shared by each pixel circuit in a row.

Preferably, the second switch transistor is connected to a voltage sensing device for sensing a voltage drop across an OLED and for generating a sensed voltage drop signal to a controller for adjusting the drive signal in response to the sensed voltage drop signal.

More preferably, the sensed voltage drop signal is provided to a lookup table for storing voltage data representing a relationship between voltage and drive signal for a characteristic OLED and the controller being programmed to adjust the drive signal in response to the relationship.

In embodiments the voltage sensing device is for sensing the voltage drop of all the OLEDs of the display and a plurality of voltage sensing devices are provided, each for sensing a voltage drop on a sub-set of the OLEDs of the display. The sensed voltage drop sensed by the voltage sensing device can be a combination of the voltage drops across a plurality of the OLEDs.

Preferably, the present invention further provides an active matrix display device further comprising a module for determining a transistor characteristic of a transistor of a pixel driver circuit from the sensed voltage drop signal.

The determined transistor characteristic can be a threshold voltage shift of the drive transistor. Particularly, the pixel driver circuits are current-programmed.

According to a second aspect of the present invention, there is provided a pixel driver circuit for driving an organic light-emitting diode (OLED) comprising: a first selection line; a data line; a first voltage supply line; and a drive transistor having a current path connected to the first voltage supply line at one end and the OLED at the other end and a gate terminal connected to a storage element connected to the data line to memorise a drive signal for the drive transistor under the control of first and second switch transistors having gate connections to the first selection line; a third switch transistor having a gate connection to a second selection line, wherein the third switch transistor is located in the current path of the drive transistor in series between the OLED and drive transistor.

Preferably, the first selection line is a non-inverted selection line and the second selection line is an inverted selection line such that when the first selection line is HIGH the second selection line is LOW. More preferably, the first voltage supply line and another selection line are formed as a combined voltage supply and selection line and optionally the another selection line is the first selection line.

Embodiments of the invention will now be described, by way of example only, with reference to the accompanying drawings in which:

FIG. 1 is a prior art example of an organic electroluminescent device;

FIG. 2 is a prior art example of a voltage driven active matrix OLED pixel circuit;

FIG. 3 is a prior art example of a current driven active matrix OLED pixel circuit;

FIG. 4a is a prior art example of a current driven active matrix OLED pixel circuit;

FIG. 4b is a timing diagram for the pixel circuit illustrated in FIG. 4a;

FIG. 5 is a pixel circuit according to a first embodiment of the present invention;

FIG. 6 is a pixel circuit according to a second embodiment of the present invention; and

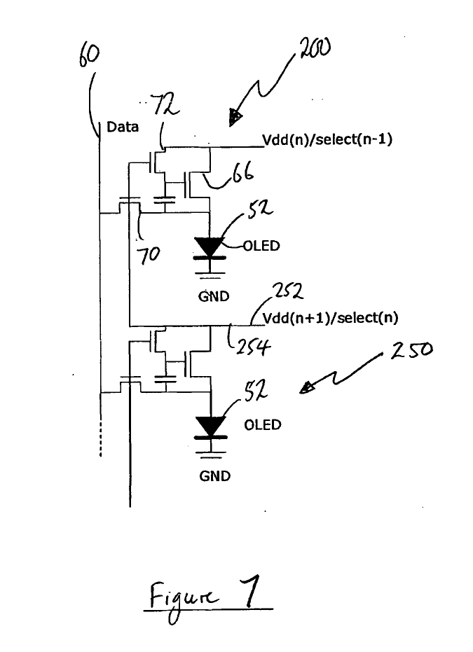

FIG. 7 is a pixel circuit according to a third embodiment of the present invention.

Referring to FIG. 5, a first embodiment of the present invention illustrates a pixel circuit 50. Such a pixel circuit 50 is provided for each OLED 52 of the overall display (not shown) of pixels. A ground 54, supply voltage rail 56, first row select 58 and column data 60 lines are provided interconnecting the pixels.

A second row select line 62 is also provided interconnecting the pixels. Accordingly each pixel circuit 50 has a common ground 54, supply voltage rail 56, and each pixel has a common first and second row select line 58, 62 and column data line 60.

The OLED 52 is connected in series with a first transistor 64 and a drive transistor 66 between supply voltage rail 56 and ground 54. The cathode terminal of the OLED 52 is connected to ground 54 and the anode terminal is connected to the supply voltage rail 56 by way of the series connection with the first transistor 64 and drive transistor 66. A gate terminal of the first transistor 64 is connected to and thereby under the control of the second row select line 62.

The drive transistor 66 has a gate terminal connected to a first terminal of a storage capacitor 68, a second terminal of which is connected to a first terminal of a switch transistor 70. A gate terminal of the switch transistor 70 is connected to and thereby under the control of the first row select line 58. A second terminal of the switch transistor 70 is connected to the column data line 60. A second transistor 72 has a gate terminal connected to and thereby under the control of the first row select line 58, a first terminal connected to the first terminal of storage capacitor 68 and gate terminal of the drive transistor 66 and a second terminal connected to the supply voltage rail 56.

In operation, the pixel circuit 50 comprises a supply voltage Vdd being applied across the pixel circuit 50 from the supply voltage rail 56 to ground 54. The programming stage comprises the first row select line 58 being HIGH thereby turning ON the switch transistor 70 and second transistor 72. At the same time, the second row select line 62 which is an inverted row select line compared to the first row select line 58 is LOW and switches off the first transistor 64. Thus OLED 52 is isolated from the voltage supply line removing a need to modulate the supply voltage between low and high levels. A voltage on column data line 60 can therefore be stored on capacitor 68. During an emission stage the first row select line is LOW thereby turning off the switch transistor 70 and second transistor 72. At the same time, the second row select line 62 is HIGH enabling the drive transistor 66 and the first transistor 64 to pass a (drain-source) current to the OLED 52.

The pixel circuit 50 of FIG. 5 (and FIGS. 6 and 7 below) are current-controlled with the addition of a current generator (not shown) on the column data line 60 as is known in the art.

Referring to FIG. 6, in which like elements to those of FIG. 5 are indicated by like reference numerals, a second embodiment of the present invention illustrates a pixel circuit 100. The pixel circuit 100 comprises an additional row select line 102.

The switch transistor 70 has a gate terminal connected to the additional row select line 102 and thereby under the control of the additional row select line 102, and a first terminal connected to a second terminal of a storage capacitor 68 and a first terminal connected to a column data line 60.

In operation, in a programming stage of the pixel circuit 100, a supply voltage Vdd is held at a low potential such that there is a substantially zero potential difference across the OLED 52. During the programming stage both the first row select line 58 and additional row select line 102 are HIGH thereby a voltage on column data line 60 can be stored on the capacitor 68. During the emission stage, the supply voltage Vdd goes to a high potential and the first row select line 58 and additional row select line 102 are LOW. Accordingly, the drive transistor 66 enables a (drain-source) current to pass through the OLED 52.

The present embodiment as illustrated in FIG. 6 includes a measurement stage whereby the additional select line 102 is HIGH and enabling a voltage drop on the column data line 60 to be measured across the OLED 52 from node 104 to ground 54. Since it is known that the voltage drop across an OLED can vary due to aging of the organic materials, the measured voltage drop is indicative of and can be used to compensate for such aging. Such a voltage drop may be measured and compared with a look up table which via a controller may require the pixel circuit 100 to be programmed with a higher or lower drive signal (voltage or current) on the column data line 60. Individual pixels may be compensated for in this way or a number of pixels may be measured and compensated for row by row or the device may be compensated for as a whole. A voltage drop over a number of OLEDs 52 may be obtained by a combination of voltage drops across a number of OLEDs 52.

Referring to FIG. 7, a third embodiment of the present invention illustrates two pixel circuits 200 and 250. In FIG. 7 like elements to these described in FIGS. 5 and 7 are indicated by like reference numerals. Referring to FIG. 7, a voltage supply line 252 of the pixel circuit 250 is shared with the row select line 254 of adjacent pixel circuit 200. Accordingly, the number of bus lines of the device is reduced. Thus the voltage supply line and row select line are combined and shared between a number of pixel circuits.

This embodiment of pixel circuit may be incorporated with embodiments 1 and 2 together or alone if a reduction in the overall number of bus lines in the device is required. Moreover, embodiment 1 may be combined with embodiment 2 if it is desired to implement a pixel circuit capable of providing a compensation for OLED aging without a need to modulate the supply voltage.

No doubt many other effective alternatives will occur to the skilled person. It will be understood that the invention is not limited to the described embodiments and encompasses modifications apparent to those skilled in the art lying within the spirit and scope of the claims appended hereto.

1. A pixel driver circuit for driving an organic light-emitting diode (OLED) comprising:
a first selection line;
a second selection line;
a data line;
a first voltage supply line; and
a drive transistor having a current path connected to the first voltage supply line at one end and the OLED at the other end and a gate terminal connected to a storage element connected between gate and source of the drive transistor to memorize a drive signal for the drive transistor under the control of a first switch transistor having a gate connection to the first selection line and a current path connected between gate and drain of the drive transistor; and, a second switch transistor having a gate connection to the second selection line, wherein the second switch transistor has a current path connected to the data line at one end and a node at the other end located between the drive transistor and the OLED.

2. A pixel driver circuit as claimed in claim 1, further comprising a third selection line and a third switch transistor having a gate connection to the third selection line, wherein the third switch transistor is located in the current path of the drive transistor in series between the OLED and drive transistor.

3. A pixel driver circuit as claimed in claim 2, wherein the first selection line is a non-inverted selection line and the third selection line is an inverted selection line such that when the first selection line is HIGH the third selection line is LOW.

4. A pixel driver circuit as claimed in 2, wherein the first and second selection lines are common.

5. A pixel driver circuit as claimed in claim 1, wherein the first voltage supply line and another selection line are formed as a combined voltage supply and selection line.

6. A pixel driver circuit as claimed in claim 1, wherein the first voltage supply line and another selection line are formed as a combined voltage supply and selection line and wherein the first and second selection lines are common.

7. A pixel driver circuit as claimed in claim 5, wherein the another selection line is the first selection line of a neighboring pixel circuit sharing a common data line.

8. A pixel driver circuit as claimed in claim 1, wherein the drive transistor is an n-type transistor.

9. A pixel circuit as claimed in claim 8, wherein the drive transistor is an amorphous silicon transistor.

10. A pixel circuit as claimed in claim 1, wherein the OLED has a current path such that an anode terminal of the OLED is connected to the drive transistor.

11. A plurality of pixel driver circuits as claimed in claim 5 and arranged in row and columns, each data line being shared by each pixel circuit in a column and each combined voltage supply line and all selection lines being shared by each pixel circuit in a row, wherein, for a particular column and during addressing the combined voltage supply and selection line of the n−1th pixel driver circuit acts as the first voltage supply line to the nth pixel driver circuit and the combined voltage supply and selection line of the n+1th pixel driver circuit acts as a selection line to the nth pixel driver circuit.

12. An active matrix display device comprising an array of pixel driver circuits as claimed in claim 1, wherein the pixel driver circuits are arranged in row and columns to form the display and each data line is shared by each pixel circuit in a column and each selection line is shared by each pixel circuit in a row.

13. An active matrix display device as claimed in claim 12, wherein the second switch transistor is connected to a voltage sensing device for sensing a voltage drop across an OLED and for generating a sensed voltage drop signal to a controller for adjusting the drive signal in response to the sensed voltage drop signal.

14. An active matrix display device as claimed in claim 13, wherein the sensed voltage drop signal is provided to a lookup table for storing voltage data representing a relationship between voltage and drive signal for a characteristic OLED and the controller being programmed to adjust the drive signal in response to the relationship.

15. An active matrix display device as claimed in claim 13, wherein the voltage sensing device is for sensing the voltage drop of all the OLEDs of the display.

16. An active matrix display device as claimed in claim 13, wherein a plurality of voltage sensing devices are provided, each for sensing a voltage drop on a sub-set of the OLEDs of the display.

17. An active matrix display device as claimed in claim 13, wherein the sensed voltage drop sensed by the voltage sensing device is a combination of the voltage drops across a plurality of the OLEDs.

18. An active matrix display device as claimed in claim 13, further comprising a module for determining a transistor characteristic of a transistor of a pixel driver circuit from the sensed voltage drop signal.

19. An active matrix display device as claimed in claim 18, wherein the transistor characteristic is a threshold voltage shift of the drive transistor.

20. An active matrix display device as claimed in claim 11, wherein the pixel driver circuits are current-programmed.

21. A pixel driver circuit for driving an organic light-emitting diode (OLED) comprising:
a first selection line;
a data line;
a first voltage supply line; and
a drive transistor having a current path connected to the first voltage supply line at one end and the OLED at the other end and a gate terminal connected to a storage element connected to the data line to memorize a drive signal for the drive transistor under the control of first and second switch transistors having gate connections to the first selection line; and,
a third switch transistor having a gate connection to a second selection line, wherein the third switch transistor is located in the current path of the drive transistor in series between the OLED and drive transistor.

21. (canceled)

22. A pixel driver circuit as claimed in claim 20, wherein the first voltage supply line and another selection line are formed as a combined voltage supply and selection line.

23. A pixel driver circuit as claimed in claim 22, wherein the another selection line is the first selection line.

24. (canceled)

25. (canceled)

26. A pixel driver circuit as claimed in claim 20, wherein the first selection line is a non-inverted selection line and the second selection line is an inverted selection line such that when the first selection line is HIGH the second selection line is LOW.
